(19) United States
(12) Patent Application Publication
(10) Pub. No.: US 2014/0225009 A1
(43) Pub. Date: Aug. 14, 2014

(54) Infrared Light Sources and Methods of Their Use and Manufacture

(71) Applicants: Wayne O'Brien, Ringgold, GA (US); Michael Myrick, Columbia, SC (US); Nicholas D. Boltin, West Columbia, SC (US); Scott J. Hoy, Richardson, TX (US)

(72) Inventors: Wayne O'Brien, Ringgold, GA (US); Michael Myrick, Columbia, SC (US); Nicholas D. Boltin, West Columbia, SC (US); Scott J. Hoy, Richardson, TX (US)

(21) Appl. No.: 14/176,201

(22) Filed: Feb. 10, 2014

Related U.S. Application Data
(60) Provisional application No. 61/762,505, filed on Feb. 8, 2013.

(51) Int. Cl. H05B 3/46

(52) U.S. Cl. CPC H05B 3/46; H05B 2203/017; H05B 2203/032
USPC 250/504 R; 140/71.5

(57) ABSTRACT

Infrared light sources, along with their methods of formation, are provided. The infrared light source can include a base substrate defining an aperture; a filament extending through the aperture defined by the base substrate; a resistive metal wire wrapped around the filament to define a coil having a first end and a second end; a high temperature coating surrounding at least a portion of the filament and the coil; a first electrode electrically connected to the first end of the coil; and a second electrode electrically connected to the second end of the coil.

### PRIORITY INFORMATION

The present application claims priority to U.S. Provisional Patent Application Ser. No. 61/762,505 titled “Infrared Light Sources and Methods of Their Use and Manufacture” of O'Brien, et al. filed on Feb. 8, 2013, the disclosure of which is incorporated by reference herein.

### BACKGROUND

An infrared lamp that is small, low-power, and exhibits a broad spectrum is a desired tool, particularly in the spectroscopy arts. The IR-18 is a commercially available infrared lamp constructed from silicon nitride (SiN) due to its broad emission spectrum. The overall efficiency of the SiN source is very high in terms of total wattage of light output per watt of electrical power input. However, while the IR-18 is small and portable, it is relatively low in total wattage and its major spectral output is outside the target wavelength of many applications. For example, the IR-18 lamp does not produce efficient spectral output in the 8 μm to 14 μm range desired by many spectroscopy applications.

As such, a need exists for an improved IR lamp that is relatively small in size and requires relatively low-power.

### SUMMARY

Objects and advantages of the invention will be set forth in part in the following description, or may be obvious from the description, or may be learned through practice of the invention.

Infrared light sources are generally provided. The infrared light source includes, in one embodiment, a base substrate defining an aperture; a filament extending through the aperture defined by the base substrate; a resistive metal wire wrapped around the filament to define a coil having a first end and a second end; a high temperature coating surrounding at least a portion of the filament and the coil; a first electrode electrically connected to the first end of the coil; and a second electrode electrically connected to the second end of the coil.

Methods are also generally provided for forming a light source. For example, in one embodiment, the method of forming the light source includes wrapping a resistive metal wire around a filament to form a coil having a first end and a second end; attaching a first electrode to the first end of the coil; attaching a second electrode to the second end of the coil; and applying a high temperature coating around the filament and the coil.

Other features and aspects of the present invention are discussed in greater detail below.

### BRIEF DESCRIPTION OF THE DRAWINGS

A full and enabling disclosure of the present invention, including the best mode thereof to one skilled in the art, is set forth more particularly in the remainder of the specification, which includes reference to the accompanying figures, in which:

FIG. 1 shows a perspective view of an uncoated light source positioned for insertion into a parabolic reflector;

FIG. 2 shows another perspective view of the uncoated light source of FIG. 1;

FIG. 3 shows a perspective view of the individual components forming the uncoated light source and parabolic reflector of FIG. 1;

FIG. 4 shows a perspective view of the light source positioned for insertion into a parabolic reflector after being coated with the high temperature coating; and

FIG. 5 shows a perspective view of the light source inserted into the parabolic reflector.

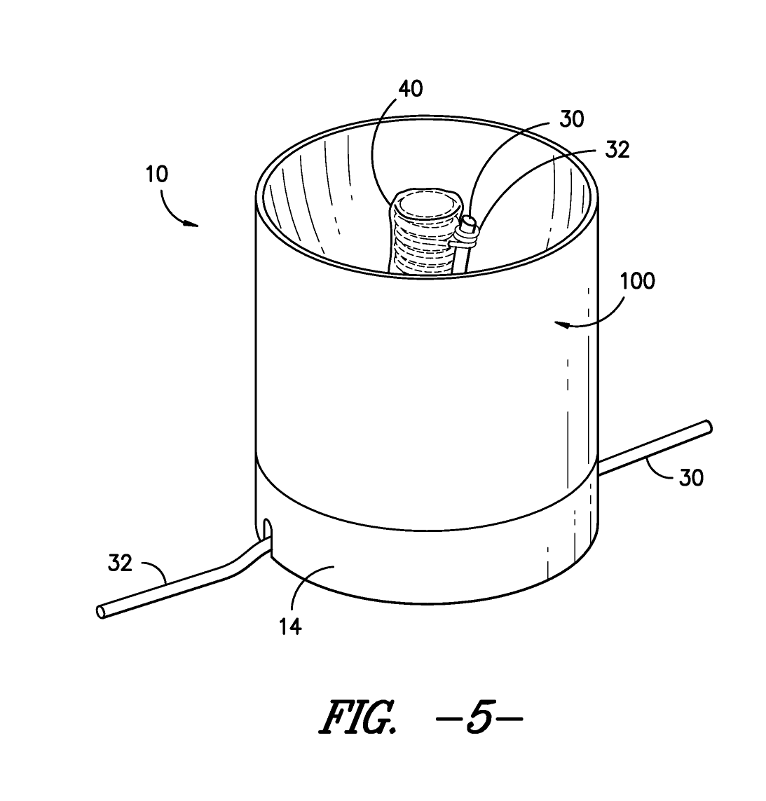

Repeat use of reference characters in the present specification and drawings is intended to represent the same or analogous features or elements of the present invention.

### DETAILED DESCRIPTION

Reference now will be made to the embodiments of the invention, one or more examples of which are set forth below. Each example is provided by way of an explanation of the invention, not as a limitation of the invention. In fact, it will be apparent to those skilled in the art that various modifications and variations can be made in the invention without departing from the scope or spirit of the invention. For instance, features illustrated or described as one embodiment can be used on another embodiment to yield still a further embodiment. Thus, it is intended that the present invention cover such modifications and variations as come within the scope of the appended claims and their equivalents. It is to be understood by one of ordinary skill in the art that the present discussion is a description of exemplary embodiments only, and is not intended as limiting the broader aspects of the present invention, which broader aspects are embodied exemplary constructions.

An infrared light source is generally provided, along with its method of formation and use. The presently disclosed infrared light source can be relatively small and portable, yet efficient at producing radiation in the spectral region of interest.

I. Light Source

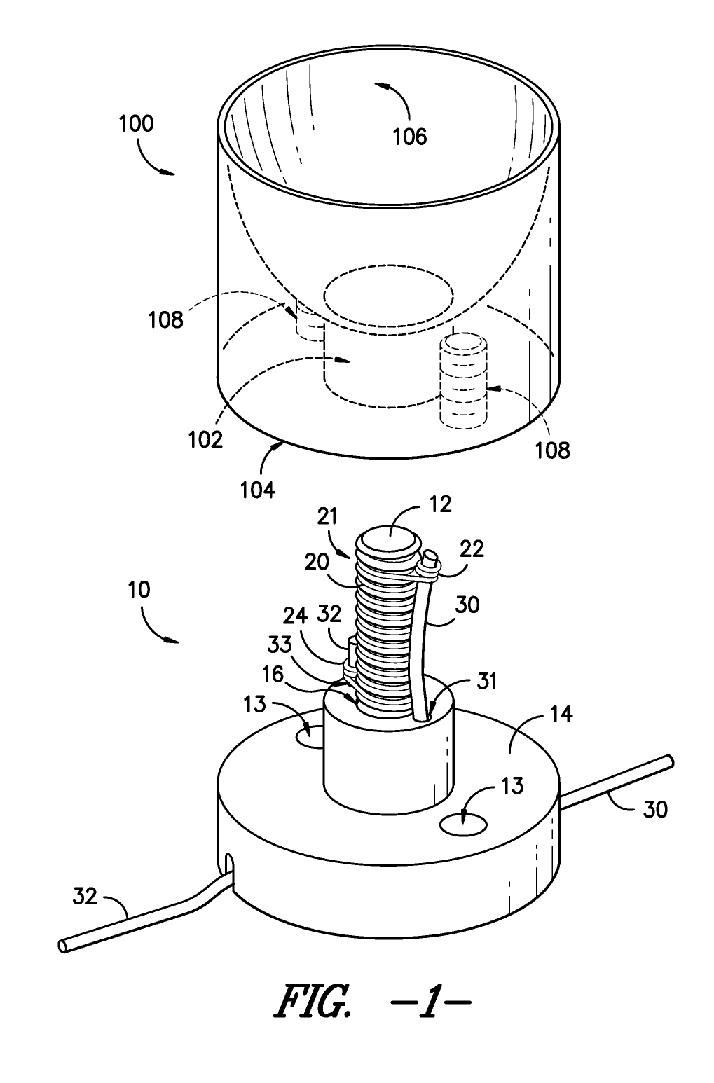

FIG. 1 shows parts of an exemplary infrared light source 10 prior to its final formation. A filament 12 is shown out of a base substrate 14. In particular, the filament extends through an aperture 16 defined in the base substrate 14. The base substrate 14 can be formed from a material configured to withstand high temperatures and be electrically insulating, such as a ceramic material, a thermoset plastic material, or the like.

Although the filament 12 is shown formed by a screw, any suitable metal can be utilized to form the filament 12 (e.g., a rod) that has a cylindrical-like shape. In particular, the filament 12 acts as an electrically insulating template structure for the coil 21 discussed below, and can include a high temperature material such as a ceramic material (e.g., a ceramic oxide material, a non-oxide ceramic, etc.). For example, the filament can constructed from a ceramic material (e.g., consisting essentially of a ceramic material) or may be ceramic-plated (e.g., a ceramic-plated stainless steel filament). In particular embodiments, suitable ceramic oxide materials include, but are not limited to, aluminum oxides (e.g., alumina having the general composition of Al₂O₃), zinc oxides (e.g., ZnO), tin oxides (e.g., SnO and SnO₂), titanium oxides (e.g., TiO and TiO₂) or mixtures thereof.

A resistive metal wire 20 is wrapped around the filament 12 to define a coil 21. A first end 22 of the coil 21 is electrically attached to a first electrode 30, and a second end 24 of the coil 21 is attached to the second electrode 32. For example, the first and second electrodes 30, 32 can be directly attached (e.g., welded) to the first and second ends 22, 24, respectively. Similarly, an opposite end of the first and second electrodes 30, 32 can be electrically attached (e.g., directly attached) to a power source (not shown), such as a battery, generator, or electric power grid.

The coil 21 is formed by a plurality of interconnected rings around the filament 12. In particular embodiments, the coil 21 can include about 5 to about 20 rings (e.g., where each wrap around the filament 12 by the wire 20 defines a ring, though not a closed ring), such as about 10 to about 15 rings. In one particular embodiment, the coil 21 can include about 11 to about 13 rings.

The resistive metal wire 20 is constructed to have a resistance low enough such that, upon the application of a current through the first end 22 to the second end 24, the resistive metal wire 20 heats itself. Due to being wrapped around the filament 12, the coil 21 concentrates this electrical heat about the circumference of the side edges of the filament 12.

In one embodiment, the resistive metal wire 20 includes alloy material. For example, the alloy material can be a chromium alloy, which includes chromium in addition to nickel (e.g., a Nichrome alloy), iron, aluminum, or mixtures thereof. In particular embodiments, for instance, the alloy material can be a Nichorme alloy (i.e., comprising chromium and nickel). For example, the resistive metal wire can include nickel in an amount of about 70% by weight to about 95% by weight (e.g., about 75% by weight to about 85% by weight). Conversely, the resistive metal wire comprises chromium in an amount of about 5% by weight to about 30% by weight (e.g., about 15% by weight to about 25% by weight). In another embodiment, for instance, the alloy material can be Kanthal A-1 (i.e., comprising chromium, iron, and aluminum).

The resistive metal wire 20 can include other suitable materials, including but not limited to, chromium, nickel, iron, aluminum, rhodium, tungsten (especially if the lamp were used under vacuum conditions to prevent oxidation of the wire), or alloys thereof.

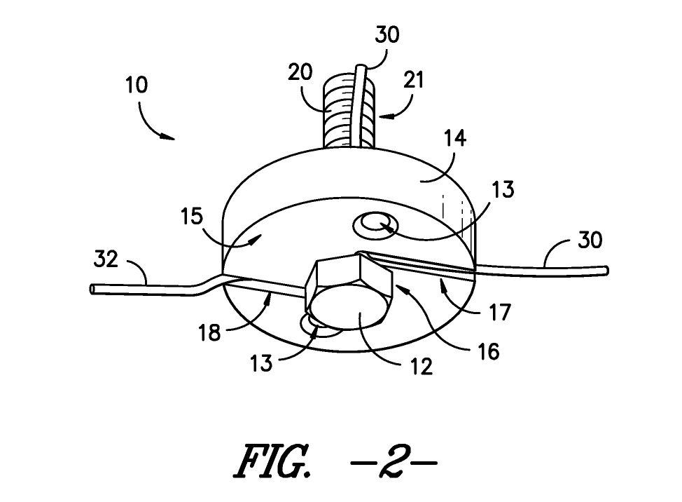

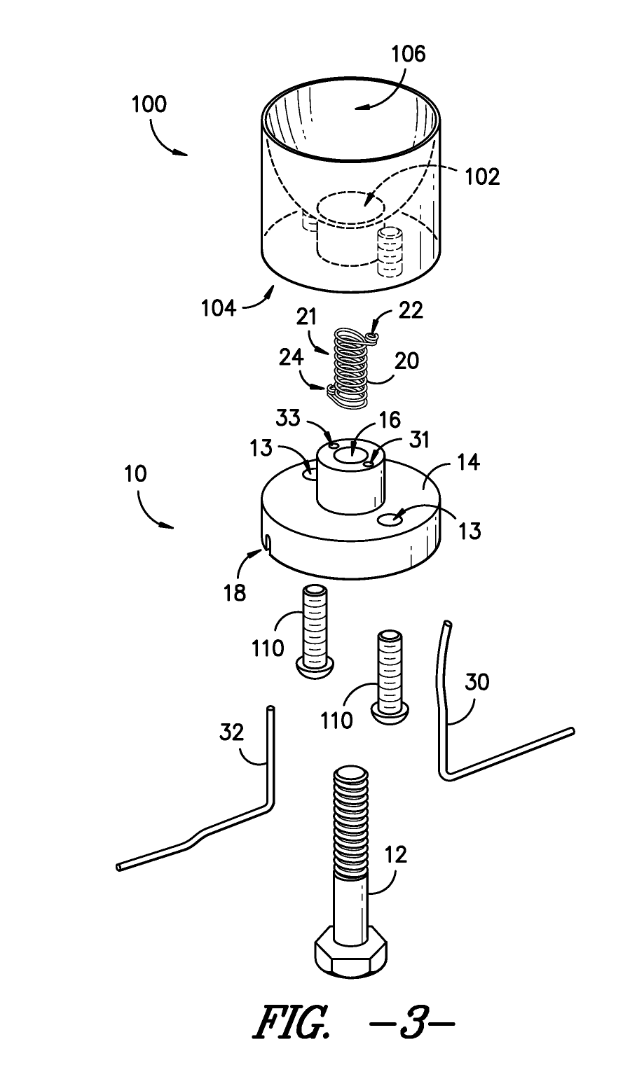

The electrodes 30, 32 are formed from a metal wire, such as a conductive material (e.g., copper, etc.) or the materials disclosed above with respect to the resistive metal wire 20. As shown in FIG. 2, the first electrode 30 is embedded into a first channel 17 defined in the back surface 15 of the base substrate 14 and through the aperture 16 with the filament 12. Similarly, the second electrode 32 is embedded into a second channel 18 defined in the back surface 15 of the base substrate 14 and through the aperture 16 with the filament 12. In one particular embodiment shown in FIG. 3, electrode apertures 31, 33 are defined in the base substrate 14 for receipt of the first electrode 30 and the second electrode 32, respectively. As such, the electrodes 30, 32 are prevented from coming into electrical contact with each other (other than through the coil 21) and/or the filament 12 and/or the parabolic reflector 100, which could electrically short the light source 10.

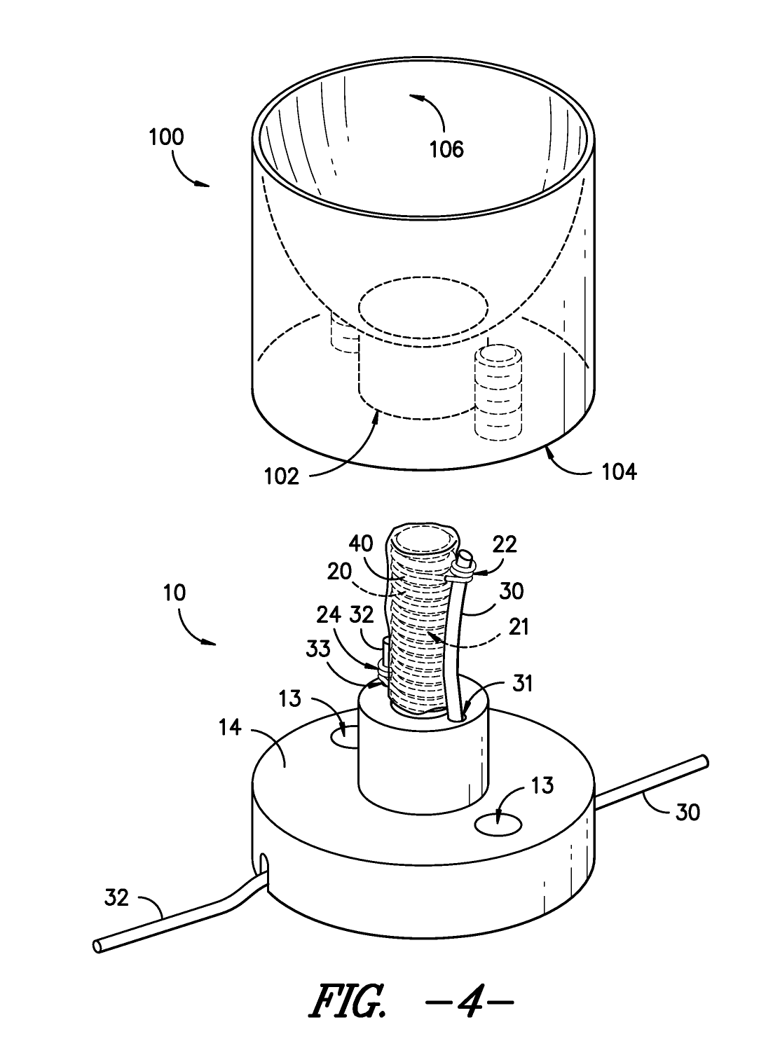

As shown in FIG. 4, a high temperature coating 40 surrounds at least a portion of the filament 12 and the coil 21. In one particular embodiment, the high temperature coating 40 surrounds the entire length of the filament 12 and the coil 21. The high temperature coating 40 can include, but is not limited to, alumina. A high temperature coating 40 of alumina can absorb the radiation energy emitted by the coil 21, and then emit that radiation energy in the infrared light spectrum. The coating 40 material can be selected based on these absorption and/or emission properties, depending on the desired spectrum of light to be emitted by the lamp 10.

Such a coating can be formed on the filament 12 and coil 21 by dipping, spraying, or wrapping (e.g., with the precursor material is a film) and then heating the light source 10 to a temperature of at least about 50° C. for at least about 30 minutes (e.g., about 75° C. to about 150° C. for about 1 hour to about 2 hours).

Upon application of electrical current through the coil 21, the high temperature coating 40 is heated by the resistive metal wire 20. The amount of power can be selected based on the materials in the lamp (e.g., the material of the resistive metal wire 20), in that enough power needs to be provided to heat the coil 21 enough to produce sufficient radiant energy to be absorbed by the high temperature coating 40, but not melt the wire 20. In one embodiment, the power source is configured to provide electrical current to the conductive filament at a power of about 50 watts or less, such as at a power of about 30 watts to about 40 watts.

Once at a sufficient temperature (e.g., about 500° F. to about 1000° F., such as about 850° F. to about 950° F.), the high temperature coating 40 emits radiant energy having wavelengths in the infrared light spectrum (e.g., about 700 nm to about 1 mm). In one particular embodiment, the infrared light source 10 has enhanced efficiency and power for generating light having a wavelength of about 8 μm to about 14 μm.

In other embodiments, the material of the high temperature coating, the amount of electrical power/current applied to the coil 21, and/or the temperature of the coil 21 can be controlled or adjusted as desired to form a light source that emits radiant energy in other light spectrums, such as the X-ray (e.g., about 0.01 nm to about 10 nm), the ultraviolet spectrum (e.g., about 10 nm to about 380 nm), the visible spectrum (e.g., about 380 nm to about 700 nm), the microwave spectrum (e.g., about 1 mm to about 1 m).

II. Parabolic Reflector

As shown, the light source 10 can be coupled with a parabolic reflector 100. For example, the coated light source 10 can be inserted through an aperture 102 defined in the base 104 of the parabolic reflector 100. As such, the high temperature coating 40 covering the filament 12 and the coil 21 is positioned within the parabolic reflector 100. Upon application of electrical current through the first and second electrodes 30, 32, the radiant energy emitted from the high temperature coating 40 covering the filament 12 and the coil 21 is reflected by the inner, reflective surface 106 of the parabolic reflector 100 to direct the radiant energy as desired.

In one embodiment, the base 104 of the parabolic reflector 100 defines at least one cavity 108 for accepting a screw 110 (or other attachment mechanism). Similarly, the base substrate 12 can define a cavity 13 for accepting a screw 110 (or other attachment mechanism). The cavity 108 in the parabolic reflector 100 and the cavity 13 in the base substrate 12 can be aligned together, and an attachment mechanism 110 (shown as a screw) can secure the light source 10 to the parabolic reflector 100 for use. Other attachment mechanisms can be utilized, as desired (e.g., adhered, bolted, taped, etc.)

III. Uses for Infrared Spectroscopy Measurement

The infrared light source 10 can be used in any infrared spectroscopy measurement, particularly into the mid-IR region.

### EXAMPLES

An infrared light source was built as shown in the Figures, using a nichrome-A heating wire wrapped around a threaded alumina post, and overcoated with alumina adhesive. The post was inserted into a 1 inch parabolic mirror used for an IR-18 lamp. The overall efficiency of the resulting infrared light source is lower than the IR-18 due to the suppression of the major blackbody emission of wavelengths below 5 μm. However, in the wavelength range of interest, 8 μm to 14 μm, the efficiency of the lamp is twice than of the IR-18 lamp and other similar blackbody sources. In addition, the total power that can be applied to the lamp is roughly double the power that can be supplied to the IR-18, meaning that it appears to be about 4 times brighter than the IR-18 in a package that is the same size.

These and other modifications and variations to the present invention may be practiced by those of ordinary skill in the art, without departing from the spirit and scope of the present invention, which is more particularly set forth in the appended claims. In addition, it should be understood the aspects of the various embodiments may be interchanged both in whole or in part. Furthermore, those of ordinary skill in the art will appreciate that the foregoing description is by way of example only, and is not intended to limit the invention so further described in the appended claims.

What is claimed:

1. A infrared light source, comprising:
a base substrate defining an aperture;
a filament extending through the aperture defined by the base substrate;
a resistive metal wire wrapped around the filament to define a coil having a first end and a second end;
a high temperature coating surrounding at least a portion of the filament and the coil;
a first electrode electrically connected to the first end of the coil; and
a second electrode electrically connected to the second end of the coil.

2. The light source as in claim 1, wherein the high temperature coating fully surrounds the filament.

3. The light source as in claim 1, further comprising:
a power source electrically connected to the first electrode and the second electrode.

4. The light source as in claim 3, wherein the power source is directly connected to the first electrode and the second electrode.

5. The light source as claim 3, wherein the power source is configured to provide electrical current to the conductive filament at a power of about 50 watts or less.

6. The light source as claim 3, wherein the power source is configured to provide electrical current to the conductive filament at a power of about 30 watts to about 40 watts.

7. The light source as in claim 1, wherein the filament comprises a metal rod.

8. The light source as in claim 7, wherein the metal rod comprises aluminum.

9. The light source as in claim 7, wherein the metal rod comprises alumina.

10. The light source as in claim 1, wherein the resistive metal wire comprises nickel and chromium.

11. The light source as in claim 1, wherein the resistive metal wire comprises nickel in an amount of about 70% by weight to about 95% by weight.

12. The light source as in claim 1, wherein the resistive metal wire comprises nickel in an amount of about 75% by weight to about 85% by weight.

13. The light source as in claim 1, wherein the resistive metal wire comprises chromium in an amount of about 5% by weight to about 30% by weight.

14. The light source as in claim 1, wherein the resistive metal wire comprises chromium in an amount of about 15% by weight to about 25% by weight.

15. The light source as in claim 1, wherein the resistive metal wire comprises rhodium.

16. The light source as in claim 1, wherein the first electrode and the second electrode comprise nickel and chromium.

17. The light source as in claim 1, wherein the first electrode is welded to the first end of the coil.

18. The light source as in claim 1, wherein the second electrode is welded to the second end of the coil.

19. The light source as in claim 1, wherein the high temperature coating comprises alumina.

20. The light source as in claim 1, wherein the base substrate comprises a ceramic material.

21. The light source as in claim 20, wherein the ceramic material comprises alumina.

22. The light source as in claim 1, further comprising:
a parabolic reflector defining an aperture, wherein the aperture is positioned at a base of the parabolic reflector, and wherein the coated, coiled, conductive filament extends through the base aperture.

23. A method of forming a light source, the method comprising:
wrapping a resistive metal wire around a filament to form a coil having a first end and a second end;
attaching a first electrode to the first end of the coil;
attaching a second electrode to the second end of the coil; and
applying a high temperature coating around the filament and the coil.
